(19) United States
(12) Patent Application Publication
(10) Pub. No.: US 2016/0211767 A1
(43) Pub. Date: Jul. 21, 2016

(54) INVERTER CONTROLLER AND CONTROL METHOD OF INVERTER DEVICE

(71) Applicant: TOYOTA JIDOSHA KABUSHIKI KAISHA, Toyota-shi, Aichi-ken (JP)

(72) Inventor: Norihisa HOTTA, Nagoya-shi (JP)

(73) Assignee: TOYOTA JIDOSHA KABUSHIKI KAISHA, Toyota-shi, Aichi-ken (JP)

(21) Appl. No.: 14/916,421

(22) PCT Filed: Sep. 19, 2014
(86) PCT No.: PCT/IB2014/001883

§ 371 Date: Mar. 3, 2016

(30) Foreign Application Priority Data
Sep. 24, 2013 (JP) 2013-197255

(51) Int. Cl. H02M 7/537; H02P 27/06

(52) U.S. Cl. CPC H02M 7/537; H02P 27/06

(57) ABSTRACT

An inverter controller is configured to control an inverter device. The inverter device is configured to generate a drive voltage of an AC load by a switching operation of a switching element that a reflux diode is connected to. The inverter controller is configured to perform a control of setting a switching speed of the switching element to be smaller on a lower level side of a magnitude of a current flowing in the AC load than on a higher level side of the magnitude of the current.

### BACKGROUND OF THE INVENTION

1. Field of the Invention

The present invention relates to control of an inverter device that generates power to be supplied to an AC load by switching an output of a DC power supply.

2. Description of Related Art

An inverter device that generates a single-phase or multi-phase AC voltage to be supplied to various power loads such as a vehicle-running motor by switching a DC source voltage has been widely used. Since a waveform to be output from the inverter device to an AC load can be controlled as desired by a controller that drives the inverter device, an output-variable control corresponding to a load state can be performed.

Since the operation of a switching element is used in the inverter device, a switching loss determined by the integration of the product of the voltage drop and the current of the switching element is caused between switching times such as a turn-on time and a turn-off time. Since the switching loss becomes larger with an increase in the switching time, an element such as an IGBT having a short switching time is often used. However, when the switching time is short, the element current steeply varies and thus an electromotive force ΔV=Ldi/dt based on an inductance value L and a current variation rate di/dt in the circuit becomes a surge voltage. The generated surge voltage may affect insulation of a stator coil of a motor or an element withstand voltage and may also serve to cause an erroneous operation of a device. Accordingly, under this trade-off relationship, techniques for implementing high-efficiency power conversion systems corresponding to various applications have been actively developed.

For example, in consideration of the fact that a dielectric strength between coils of a motor decreases depending on the environment, Japanese Patent Application Publication No. 2012-231644 (JP 2012-231644 A) discloses a technique of reducing a transient overvoltage in an environment in which the dielectric strength decreases. This technique suppresses dielectric breakdown that occurs when applying a voltage stress due to a transient overvoltage (surge voltage) between coil conductors adjacent to each other in the same phase of the motor to enlarge a potential difference based on intra-phase divided voltages. An example of such a technique is controlling a switching element of an inverter at a low switching speed when a current flowing in the motor increases.

In the inverter device, it is known that a recovery surge voltage is generated in a reflux diode connected in inverse parallel to the switching element at the time of commutation. The recovery surge voltage has a characteristic that the smaller the current becomes, the larger the recovery surge voltage becomes. Accordingly, when a current is small, the recovery surge voltage superimposed on the surge voltage AV becomes larger and the surge voltage as a whole particularly becomes larger. At this time, when the dielectric strength between the coils is not sufficient, dielectric breakdown occurs between the coil conductors adjacent to each other in the same phase to which the surge voltage is applied. There is a possibility that failure such as vehicle stoppage occurs when the dielectric breakdown occurs and a large current flows in the motor.

In order to prevent the dielectric breakdown between the coil conductors, it can be considered that an insulating resin of the coil be replaced with a resin configured to withstand high voltage or be increased in thickness with respect to a present level of a surge voltage, but this method may increase the cost or may cause the size of the motor to increase.

In order to prevent the dielectric breakdown, it may also be considered that the switching speed of the inverter be uniformly decreased to suppress the current variation rate di/dt, from the viewpoint that the surge voltage is suppressed to set the divided voltages of the motor coil in terms of instantaneous voltages to always be equal to or less than a dielectric withstand voltage. However, in this method, since the switching time increases, the switching loss increases to lower energy efficiency and to degrade fuel efficiency, for example, in a vehicle. When the switching loss increases, an amount of heat emitted also increases. Accordingly, when an insulating material having a high temperature specification is selected so that the temperature of the switching element does not rise above a guaranteed heat-resistance temperature, the cost increases.

The recovery surge voltage increases with the decrease in the current as described above. Accordingly, the potential difference between the coil conductors in the same phase generated at the time of turning on the switch increases when the voltage applied to the coil is high and the current flowing in the coil is small. That is, the divided voltages in the motor coil increase when the current is small, and the large current state which causes a problem with the guaranteed heat-resistance temperature does not have a direct relationship with the increase in the divided voltages.

In this way, in the control of the inverter device in the related art, a surge voltage reducing technique for effectively suppressing an increase in divided voltages in the motor coil while appropriately suppressing the switching loss has not been devised.

### SUMMARY OF THE INVENTION

The invention provides an inverter controller that can actively reduce a surge voltage while appropriately suppressing a switching loss and a control method of an inverter device.

According to a first aspect of the invention, there is provided an inverter controller configured to control an inverter device that is configured to generate a drive voltage of an AC load by a switching operation of a switching element connected to a reflux diode. The inverter controller is configured to perform a control of setting a switching speed of the switching element to be smaller on a lower level side of a magnitude of a current flowing in the AC load than on a higher level side of the magnitude of the current.

According to a second aspect of the invention, there is provided an inverter controller configured to control an inverter device that is configured to generate a drive voltage of an AC load by a switching operation of a switching element connected to a reflux diode. The inverter controller is configured to perform a control of setting a switching speed of the switching element to be smaller on a lower level side of a magnitude of a current flowing in the AC load than on a higher level side of the magnitude of the current when an input voltage to the inverter device is greater than a predetermined voltage value.

According to a third aspect of the invention, there is provided an inverter controller configured to control an inverter device that is configured to generate a drive voltage of an AC load by a switching operation of a switching element connected to a reflux diode. The inverter controller is configured to perform a control of setting a switching speed of the switching element to be smaller on a lower level side of the magnitude of a current flowing in the AC load than on a higher level side of the magnitude of the current when atmospheric pressure of a surrounding environment is equal to or less than a predetermined pressure.

According to a fourth aspect of the invention, there is provided an inverter controller configured to control an inverter device that is configured to generate a drive voltage of an AC load by a switching operation of a switching element connected to a reflux diode. The inverter controller is configured to perform a control of setting a switching speed of the switching element to be smaller on a lower level side of a magnitude of a current flowing in the AC load than on a higher level side of the magnitude of the current when an input voltage to the inverter device is greater than a predetermined voltage value and atmospheric pressure of a surrounding environment is equal to or less than a predetermined pressure.

In any one of the first to fourth aspects, the AC load may be a motor.

According to a fifth aspect of the invention, there is provided a control method of an inverter controller configured to control an inverter device configured to generate a drive voltage of an AC load by a switching operation of a switching element connected to a reflux diode. The control method includes setting a switching speed of the switching element to be smaller on a lower level side of the magnitude of a current flowing in the AC load than on a higher level side of the magnitude of the current.

According to the first aspect, when the current flowing in the AC load is at a lower level, the switching speed of the switching element decreases. Accordingly, as the electromotive force based on the product of inductance of the circuit and a current variation rate decreases, the total magnitude of a surge voltage on which a recovery surge voltage generated in the reflux diode is superimposed can be made to decrease. On the other hand, when the current flowing in the AC load is at a level at which the recovery surge voltage is small and the total surge voltage does not increase much, the switching speed of the switching element is not made to decrease and it is thus possible to reduce the switching loss. Accordingly, it is possible to provide an inverter controller that can greatly reduce the surge voltage while suitably reducing the switching loss over the total inverter operating time.

According to the second aspect, the surge voltage can be reduced when the input voltage to the inverter device is high and thus the voltage applied to the load particularly increases.

According to the third aspect, the surge voltage can be reduced when the atmospheric pressure of the surrounding environment decreases and thus the dielectric strength decreases.

According to the fourth aspect, when the input voltage to the inverter device is high and thus the voltage applied to the load particularly increases and when the atmospheric pressure of the surrounding environment decreases and thus the dielectric strength decreases, it is possible to reduce the surge voltage.

According to any one of the first to fourth aspects, when the AC load is a motor and the motor current is small, it is possible to prevent the insulating resin from causing dielectric breakdown which can easily occur by an increase in the potential difference due to divided voltages between the motor coil conductors in the same phase.

According to the fifth aspect, it is possible to provide a control method of an inverter device that can greatly reduce the surge voltage while suitably reducing the switching loss over the total inverter operating time.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart illustrating a control sequence which is performed by an inverter controller according to an embodiment of the invention;

FIG. 2 is a circuit block diagram illustrating a configuration of a motor drive system including the inverter controller according to the embodiment of the invention;

FIG. 3 is a drive waveform diagram illustrating a control of switching a switching speed, which is performed by the inverter controller according to the embodiment of the invention;

FIG. 4 is a circuit block diagram illustrating a configuration example of a motor drive system including an inverter controller;

FIG. 5 is a diagram illustrating a temporal variation of voltages and currents, which is used to describe a recovery surge voltage according to the embodiment of the invention;

FIG. 6A is a block diagram illustrating a configuration of the inverter controller according to the embodiment of the invention when switching speed control is performed depending on a computer configuration; and

FIG. 6B is a block diagram illustrating a configuration of an inverter controller according to the embodiment of the invention when the switching speed control is performed depending on a hardware configuration.

### DETAILED DESCRIPTION OF EMBODIMENTS

An embodiment of the invention will be described below with reference to the accompanying drawings.

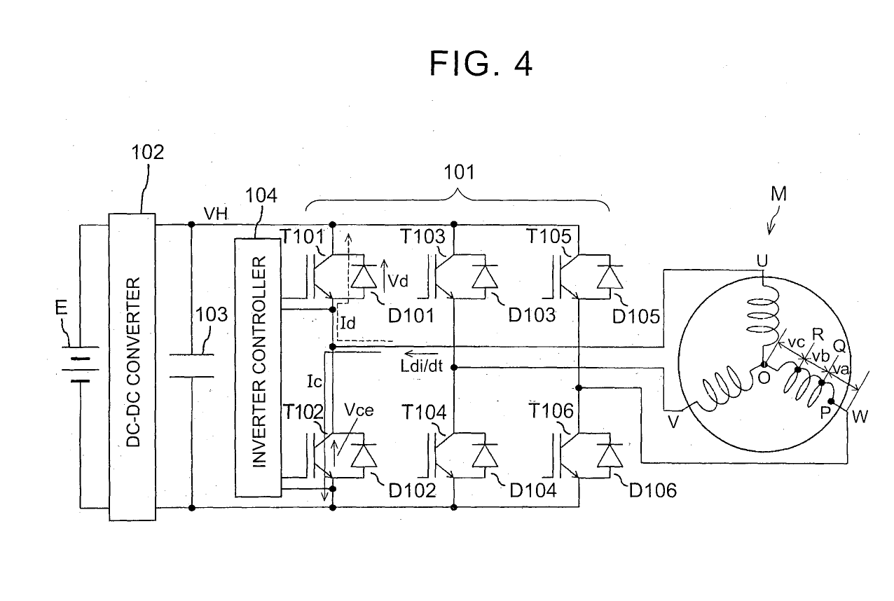

First, a recovery surge voltage generated in an inverter device will be described below. FIG. 4 illustrates a configuration example of a voltage inverter that generates AC power to be supplied to a three-phase AC motor for running a vehicle. The inverter device 101 includes switching elements T101 to T106 and reflux diodes D101 to D106. Each of the switching elements T101 to T106 may be an insulated gate bipolar transistor (IGBT) and so on. The output voltage of a battery E is boosted by a DC-DC converter 102 and is smoothed by an input capacitor 103. An inverter controller 104 uses a voltage between terminals of the input capacitor 103 as an input and generates phase voltages of a motor M, for example, by turning on and off the switching elements T101, T103, and T105 of an upper arm and the switching elements T102, T104, and T106 of a lower arm in the respective legs of a U phase, a V phase, and a W phase through a PWM control so as to have phase differences between phases. FIG. 4 illustrates a state where the output of the inverter controller 104 is connected to a node between the gate and the emitter of the switching elements T101 and T102 of the U-phase leg. The switching elements T103 and T104 of the V-phase leg and the switching elements T105 and T106 of the V-phase leg are also connected in the same manner as the U-phase leg.

In the inverter device having this configuration, a state where one of two switching elements of each leg is turned on and the other is turned off is alternately repeated. For example, in the U phase of FIG. 4, a gate drive pulse signal is input from the inverter controller 104 to the switching elements T101 and T102, and the same, gate driving is performed on the V phase and the W phase so as to sequentially shift the phase by 2/3π. However, since a dead time in which the switching elements T101 and T102 are simultaneously turned off is provided so that a large through-current does not flow by overlapping a turn-one period and a turn-off period with each other between the upper and lower arms of each leg, a current can flow via any reflux diode of the upper and lower arms depending on the direction of the current in the dead time so as to maintain the sum of the three-phase currents.

In the U phase, it is assumed that a state where the switching element T101 is turned on and the switching element T102 is turned off is switched to a state where the switching element T101 is turned off and the switching element T102 is turned on via the dead time. In the dead time, a diode current Id starts flowing in the reflux diode D101. Thus, commutation causing the diode current Id to transition into a collector current Ic flowing through the switching element T102 is carried out.

By generation of the above-mentioned surge voltage, in the coil having the phase to which the surge voltage is applied, the potential difference between coil conductors, which have been wound on a stator, adjacent to each other in the same phase becomes larger than the potential difference due to the normal divided voltages. For example, as illustrated in FIG. 4, the divided voltages between points P and Q, between points Q and R, and points R and O out of the voltages applied to the W coil are sequentially va, vb, and vc. When point U, point Q, and point R are close to each other on the wound coils, and the divided voltages va, vb, and vc become greater than those in the normal state at the time at which the generated surge voltage is applied to the W phase and is superimposed on the voltage applied to the W-phase coil, and thus, for example, the potential difference va+vb between points P and R becomes particularly large among the potential differences between the points. The potential difference generated between the coil conductors at the time of this transient overvoltage needs to be suppressed to be equal to or less than the withstand voltage of a resin used for insulating the coils from each other.

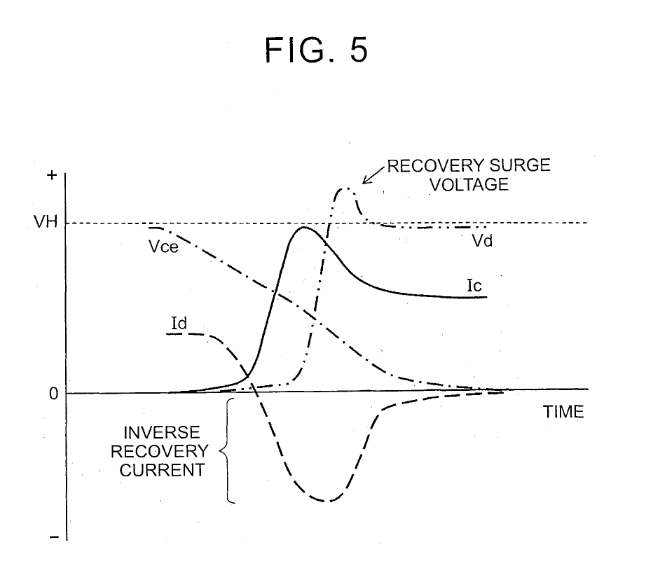

A mechanism of generating the surge voltage in the inverter device will be described below in brief. The surge voltage is generated at the time of switching on the inverter device and at the time of switching off the inverter device. A recovery surge voltage is generated in the reflux diode as a commutation source in addition to the above-mentioned electromotive force Ldi/dt at the time of switching on the inverter device. For example, in the U phase of FIG. 4, the recovery surge voltage is generated in the reflux diode D101 of one arm at the time of turning on the switching element T102 of the other arm. When the turning-on operation of the switching element T102 is started from the dead time as illustrated in FIG. 5, the collector-emitter voltage Vice of the switching element T102 decreases, the collector current Ic increases, and the diode current Id flowing in the forward direction (indicated by the plus side in the vertical axis) of the reflux diode D101 is intercepted. Thereafter, since positive and negative carriers are accumulated by the reverse bias in the reflux diode D101 and thus a reverse recovery current flows therein, the diode current Id goes into a reverse region (a region on the minus side in the vertical axis). The reverse recovery current is maximized at a certain point of time by combination and annihilation of positive and negative carriers and then decreases to zero.

In the course of decreasing of the reverse recovery current, the recovery surge voltage is generated, the voltage Vd applied to the reflux diode D101 rapidly increases and forms a peak waveform greater than an input voltage VH to the inverter device 101.

In the configuration illustrated in FIG. 4, such a phenomenon occurs that the surge voltage on which the recovery surge voltage generated in the U-phase reflux diode D101 is superimposed is applied to the W phase in the path passing through the turned-on switching element T105 and dielectric breakdown is caused between the coil conductors in the W phase.

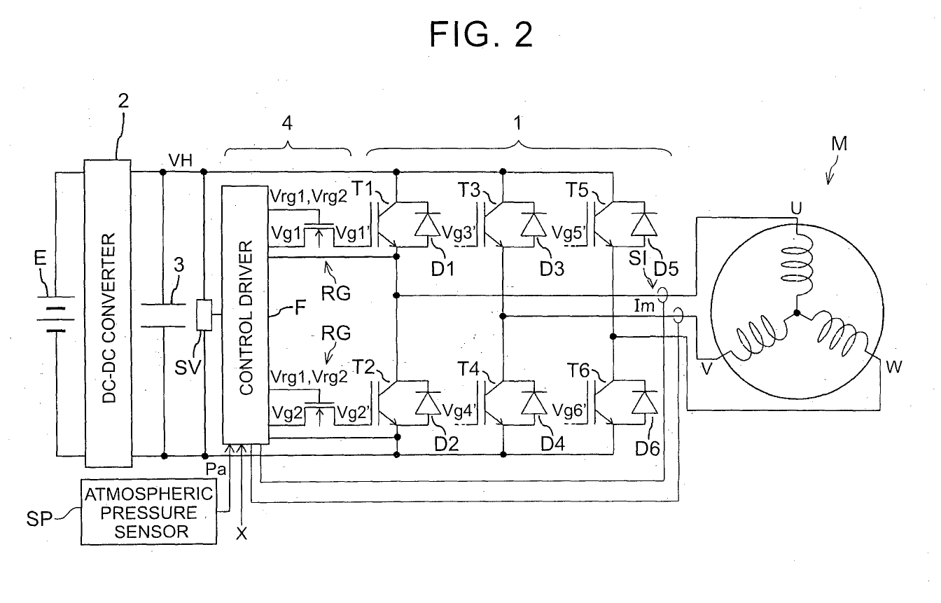

FIG. 2 illustrates a configuration of a motor drive system including the inverter controller according to the embodiment of the invention. The motor drive system includes an inverter device 1, a DC-DC converter 2, an input capacitor 3, an inverter controller 4, a battery E, and a voltage sensor SV, a current sensor SI, and the atmospheric pressure sensor SP. A motor M to be driven is constituted, for example, by a synchronous electric motor or an induction electric motor used for a hybrid vehicle (HV) and is herein illustrated as a three-phase AC motor.

The inverter device 1 forms a three-phase bridge circuit that generates a drive voltage of the motor M. An upper arm of a U-phase leg is provided with a switching element T1 and a reflux diode D1, a lower arm of the U-phase leg is provided with a switching element T2 and a reflux diode D2, an upper arm of a V-phase leg is provided with a switching element T3 and a reflux diode D3, a lower arm of the V-phase leg is provided with a switching element T4 and a reflux diode D4, an upper arm of a W-phase leg is provided with a switching element T5 and a reflux diode D5, and a lower arm of the W-phase leg is provided with a switching element T6 and a reflux diode D6. Each switching element is an IGBT herein. The reflux diodes of each arm are connected in inverse parallel to the corresponding switching elements.

The DC-DC converter 2 is a booster circuit that boosts a DC output voltage of the battery E in a voltage-variable manner. For example, a booster ratio is variable with respect to a rated voltage of 650 V so as to set 500 V or other voltage values. The output voltage of the DC-DC converter 2 is input to and smoothed by the input capacitor 3 connected in parallel to the output of the DC-DC converter 2. The output voltage VH of the input capacitor 3 becomes the input voltage to the inverter device 1.

The inverter controller 4 is a circuit that controls the operation of the inverter device 1. The inverter controller 4 calculates a torque to be applied to the motor M from an input accelerator opening X and controls duty factors of the switching elements T1 to T6. An example of the control method is a pulse width modulation (PWM) method and a control of adding modulation thereto is also carried out. The inverter controller 4 can be constituted, for example, as a circuit in which a hybrid ECU, a motor ECU, and an inverter drive circuit are combined.

The inverter controller 4 includes a control driver F and resistor circuits RG individually connected to drive control terminals (gate terminals) of the switching elements T1 to T6. The control driver F generates source drive signals (source drive voltages Vg1 to Vg6 to be described later) as input signals to the resistor circuits RG and Control signals (gate voltages Vrg1 and Vrg2 to be described later) to the resistor circuits RG Each resistor circuit RG varies the magnitude of an input resistance connected to the drive control terminal of the corresponding switching element on the basis of the control signal input from the control driver F. Accordingly, each resistor circuit RG converts the waveform of the input source drive signal into the waveform of the drive signal (gate drive voltages Vg1′ to Vg6′ to be described later) to be input to the drive control terminals of the corresponding switching element and outputs the converted signal. In this way, the waveform of the drive signal output from the control driver F varies depending on the magnitude of the corresponding input resistance and thus the switching times vary depending on the switching speeds of the switching elements T1 to T6.

In FIG. 2, the resistor circuit RG of which the input resistance is variable in this way is conceptually illustrated as a MOS transistor (which is illustrated in only the switching elements T1 and T2 for the purpose of convenience of illustration). A node between the drain and the source of the MOS transistor is connected between the drive signal output of the control driver F and the drive control terminal (gate terminal) of the switching element, and the MOS transistor is driven in a linear region (constant-resistance region). It is preferable that the MOS transistor have a high withstand voltage. By switching and applying two types of gate voltages Vrg1 and Vrg2 to the gate terminal of the MOS transistor from the control driver F, the drain-source resistor, that is, the input resistor, is switched to the two types rg1 and rg2. Accordingly, the source gate drive voltage Vg (which is illustrated as Vg1 and Vg2 in FIG. 2 but in which there are Vg1 to Vg6 sequentially corresponding to the switching elements T1 to T6) generated and output from the control driver F is applied to the drive control terminal capacitor (gate-emitter capacitor) of the corresponding switching element via the input resistor rg1 or rg2. The input resistor is also referred to as a gate resistor when the drive control terminal is referred to as a gate terminal as illustrated in FIG. 2. In the below description, the drive control terminal of a switching terminal is referred to as a gate terminal and the input resistor is referred to as a gate resistor on the basis of the example illustrated in FIG. 2.

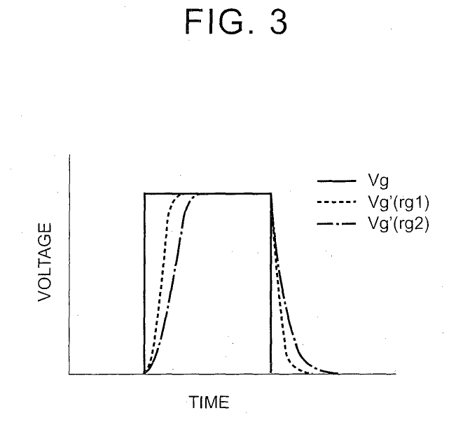

As illustrated in FIG. 3, when a rectangular pulse is output as the source gate drive voltage Vg, the waveform of the gate drive voltage Vg′ (Vg1′ to Vg6′ sequentially corresponding to the switching elements T1 to T6 in FIG. 2) varies in accordance with a time constant based on the charging of the drive control terminal capacitor of the corresponding switching element via the gate resistor rg1 or rg2. The gate drive voltage Vg′ increases and decreases to become faster when the condition rg1<rg2 is established and the gate resistor is set to rg1 and to become slower when the input resistor is set to rg2. That is, a higher switching speed (that is, a shorter switching time) of the switching element is obtained when the gate resistor is set to rg1, and a lower switching speed (that is, a longer switching time) of the switching element is obtained when the gate resistor is set to rg2.

The voltage sensor SV is a DC sensor and detects the input voltage to the inverter device 1 in a state not including a noise component such as a surge voltage. The current sensor SI detects a motor current Im and transmits the detected motor current to the inverter controller 4. The atmospheric pressure sensor SP detects the atmospheric pressure Pa of an environment to which an apparatus/device including the motor drive system is exposed such as the surrounding of the vehicle and transmits the detected atmospheric pressure to the inverter controller 4.

In the motor drive system having the above-mentioned configuration, the inverter controller 4 switches the gate resistors of the switching elements T1 to T6 between rg1 and rg2 depending on the magnitude of the motor current Im detected by the current sensor SI. Here, the magnitude of the detected motor current Im appears as an effective value, a peak value, a rectified mean value, or the like. When the magnitude of the motor current Im is equal to or greater than a switching threshold value expressed by a predetermined current value such as 100 A, the inverter controller 4 outputs the gate voltage Vrg1 to the MOS transistor used as the gate resistor and sets the gate resistor to rg1 which is the smaller value. When the magnitude of the motor current Im is less than the switching threshold value, the inverter controller 4 outputs the gate voltage Vrg2 to the MOS transistor used as the gate resistor and sets the gate resistor to rg2 which is the larger value.

In this way, the inverter controller 4 performs a control of setting the switching speeds of the switching elements T1 to T6 to be lower on the lower level side of the magnitude of the motor current Im than on the higher level side of the magnitude of the motor current Im. A threshold value representing the boundary between the lower level side and the higher level side can be set to a value equal to or more than the lower limit (for example, zero) of a range in which the magnitude of the motor current Im can vary. Alternatively, the threshold value may vary depending on the environment condition. This does not mean that the lower the level of the motor current Im becomes, the lower the switching speed becomes. For example, when the range in which the magnitude of the motor current Im can vary is divided into a higher-level region and a lower-level region, the switching speed in the lower-level region is set to be lower than that in the higher-level region, but the switching speed may be set to be higher when the magnitude of the motor current Im becomes lower in the lower-level region. This is helpful in that any unnecessary increases in switching loss may not be caused by limitlessly decreasing the switching speed, for example, when a local maximum value is obtained in the increase in magnitude of the surge voltage while the magnitude of the motor current Im decreases.

When the recovery surge voltage generated in a reflux diode by the control of the inverter controller 4 is small and thus the total surge voltage is relatively small, the switching speed is increased by the smaller gate resistor rg1 to suppress the switching loss. When the recovery surge voltage generated in a reflux diode is large and thus the total surge voltage is relatively large, the switching speed is increased by the larger gate resistor rg2 to secure insulation between the coil conductors. In this way, by decreasing the switching speed to suppress ΔV=Ldi/dt only when the motor current is at a predetermined lower level, it is possible to suppress the magnitude of the total surge voltage on which the recovery surge voltage is superimposed and it is thus possible to prevent dielectric breakdown of an insulating resin which can easily occur between the coil conductors while suitably suppressing the switching loss over the total inverter operating time. Particularly, since a large surge voltage generated at the time of turning on the switching element can be suppressed, the effect of preventing the dielectric breakdown is great. That is, the inverter controller 4 can enable surge voltage reduction effectively suppressing an increase in divided voltages in the motor coils particularly at the time of turning on the switching elements T1 to T6 while suitably suppressing the switching loss.

As can be seen from the description of the divided voltages in FIG. 4, since the higher the system voltage VH becomes, the larger the coil-applied voltage (voltage between points P and 0) becomes, the higher the system voltage VH becomes, the larger the potential difference between the coil conductors at the time of generating a surge voltage becomes. Accordingly, only when the magnitude of the motor current Im is less than a predetermined value and the system voltage VH is higher than a predetermined voltage value, the inverter controller 4 may set the gate resistor to rg2. For example, since the lower the atmospheric pressure becomes, the lower the dielectric strength between the coil conductors becomes, a control of limiting the system voltage VH under the atmospheric pressure at a height H may be carried out in a hybrid vehicle so as to decrease the system voltage VH. In this case, for example, a specification in which the maximum voltage of the system voltage VH at the height H is Vth2 and the system voltage VH at which a fuel efficiency operating point is a maximum is Vth1 (Vth1<Vth2) is determined. Accordingly, the control of setting the gate resistor to rg2 can be performed in a place having a large height in an actual use range of Vth1<VH≦Vth2 in which the fuel efficiency is lowered and the voltage is high. Whether the height is equal to or greater than H can be determined, for example, depending on whether the atmospheric pressure Pa measured by the atmospheric pressure sensor SP is equal to or less than a predetermined pressure Pth.

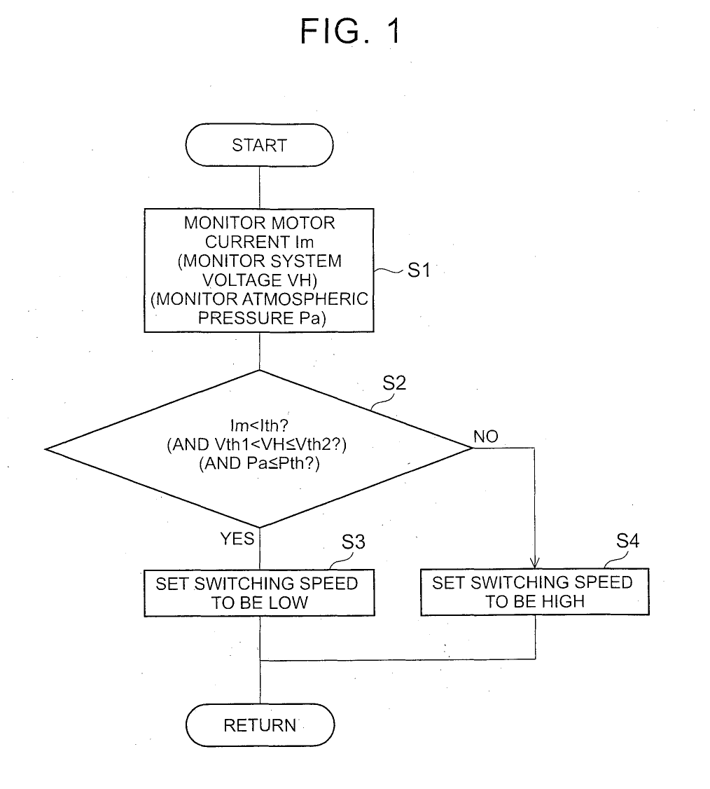

An example of the control sequence of the inverter operation by the inverter controller 4 will be described below with reference to the flowchart illustrated in FIG. 1. This control can be performed by configuring the inverter controller 4 to execute a program read from a memory by a processor, may be performed by hardware, or may be embodied using both the execution of the program and the hardware operation.

In step S1, the inverter controller 4 monitors the detected value of the motor current Im transmitted from the current sensor SI at a predetermined sampling cycle. In addition, the inverter controller 4 may monitor the detected value of the system voltage VH transmitted from the voltage sensor SV or the detected value of the atmospheric pressure Pa transmitted from the atmospheric pressure sensor SP.

Subsequently, in step S2, the inverter controller 4 determines whether to satisfy, for example, a condition in which the motor current Im is less than a predetermined current value Ith (which can be set to a value such as 100 A) with which the recovery surge voltage is likely to increase on the basis of the monitored values. When the system voltage VH is detected in step S1, it may be determined whether to satisfy, for example, a condition in which the system voltage VH is in a range greater than a predetermined voltage value Vth1 (which can be set to a value such as 400 V) and equal to or less than an upper limit voltage value Vth2 (which can be set to a value such as 500 V). When the atmospheric pressure Pa is detected in step S1, it may be determined whether to satisfy, for example, a condition in which the atmospheric pressure Pa is equal to or less than a predetermined pressure Vth. When the system voltage VH and the atmospheric pressure Pa are detected in step S1, it may be determined whether to satisfy a condition in which the system voltage VH is in a range greater than the predetermined voltage value Vth1 and equal to or less than the upper limit voltage value Vth2 and the atmospheric pressure Pa is equal to or less than the predetermined pressure Pth. The control sequence goes to step S3 when the necessary conditions are satisfied, and the control sequence goes to step S4 when the necessary conditions are not satisfied. When the system voltage VH is greater than the upper limit voltage value Vth2, a step of determining that the system is abnormal may be provided.

In step S3, the inverter controller 4 sets the gate drive voltage Vg′ of the switching elements T1 to T6 to a waveform having a slow ascent and a slow descent, that is, decreases the switching speed, by outputting the gate voltage Vrg2 to the MOS transistor of the gate resistor circuit RG to set the gate resistor to rg2.

In step S4, the inverter controller 4 sets the gate drive voltage Vg′ of the switching elements T1 to T6 to a waveform having a rapid ascent and a rapid descent, that is, increases the switching speed, by outputting the gate voltage Vrg1 to the MOS transistor of the gate resistor circuit RG to set the gate resistor to rg1.

In this way, steps S1 to S4 are repeatedly performed in the period in which the motor M is used.

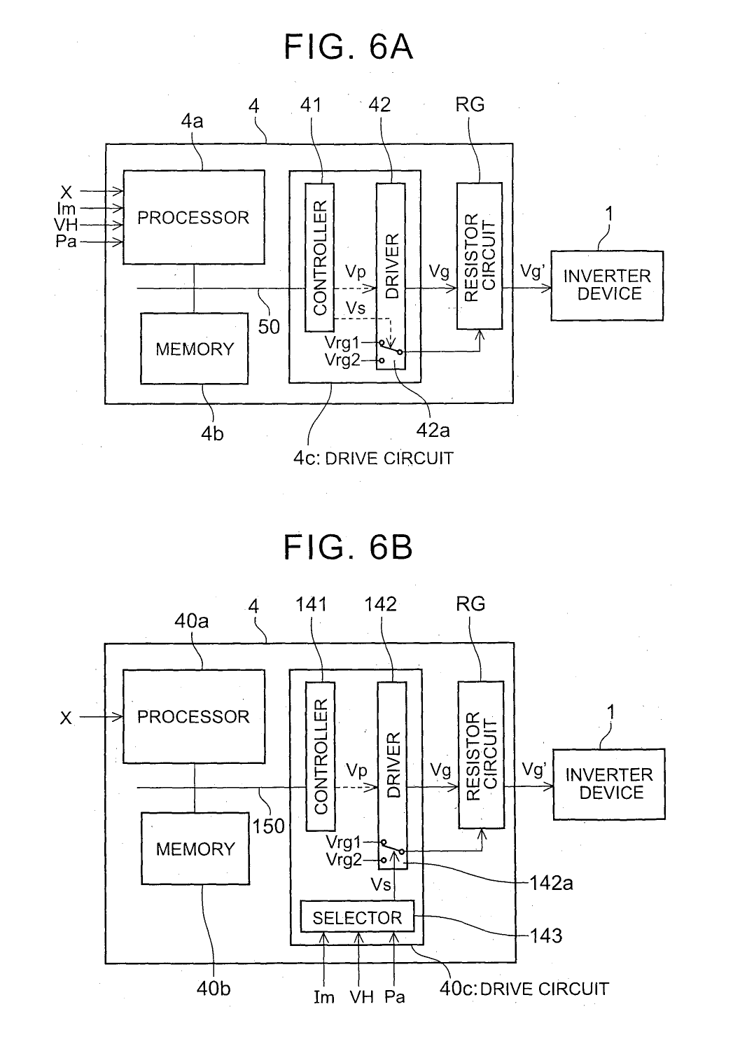

FIG. 6A is a conceptual diagram illustrating a configuration example for performing a switching speed control in the inverter controller 4. The inverter controller 4 includes a processor 4a, a memory 4b, a drive circuit 4c, and a resistor circuit RG, which are connected to each other via a communication bus 50. The processor 4a, the memory 4b, and the drive circuit 4c constitutes the control driver F illustrated in FIG. 2.

The processor 4a performs the processes of the flowchart. The accelerator opening X and the detected value of the motor current Im are input to the processor 4a, and the detected value of the system voltage VH, the detected value of the atmospheric pressure Pa, and the like are input thereto if necessary for the switching speed control. The processor 4a calculates a signal waveform for driving the inverter device 1 from the accelerator opening X or the rotation position or the rotation speed of the motor M which is fed back if necessary, and transmits an instruction on the signal waveform to the drive circuit 4c via the communication bus 50. The processor 4a calculates a switching speed to be given to the switching elements T1 to T6 of the inverter device 1 from the detected values, and transmits an instruction on the switching speed to the drive circuit 4c via the communication bus 50.

The memory 4b includes a nonvolatile memory and a volatile memory and a processing program of the flowchart is stored in the nonvolatile memory. The processing program read from the nonvolatile memory is loaded into the volatile memory and data input from the outside, data in computation processes, or the like is also temporarily stored therein.

The drive circuit 4c includes a controller 41 and a driver 42. The controller 41 receives the instruction on the signal waveform to be output to the inverter device 1 via the communication bus 50 from the processor 4a, generates a drive control signal Vp using a carrier generating circuit and a comparator therein, and outputs the generated control signal to the driver 42. The drive control signal Vp is input to the driver 42 via a photo coupler, a pulse transformer, or the like in order to insulate the controller 41 and the driver 42 from each other. The driver 42 generates source gate drive voltages Vg1 to Vg6 on the basis of the drive control signal Vp and outputs the generated source gate drive voltages to the resistor circuits RG. The driver 42 includes a switch circuit 42a. The switch circuit 42a selects a voltage source outputting the voltage Vrg1 or a voltage source outputting the voltage Vrg2, for example, on the basis of a switching signal Vs input from the controller 41 via the photo coupler, and outputs the gate voltage Vrg1 or Vrg2 to the resistor circuit RG. The resistor circuit RG generates gate drive voltages Vg1′ to Vg6′ to be output to the switching elements T1 to T6 of the inverter device 1 as waveforms corresponding to the gate voltages Vrg1 and Vrg2 on the basis of the source gate drive voltages Vg1 to Vg6.

Here, the controller 41 performs a control of switching the gate voltages Vrg1 and Vrg2 in the driver 42 in response to an instruction from the processor 4a, but the switch circuit 42a may not be provided and the controller 41 may superimpose a control signal to be applied to the resistor circuit RG as a bias component on the drive control signal Vp to be transmitted via the photo coupler in response to the instruction from the processor 4a. The bias component may be separated and may be amplified in power in the driver 42 and may be used as the gate voltage of the MOS transistor.

In the above-mentioned configuration illustrated in FIG. 6A, the control of switching the switching speeds of the switching elements T1 to T6 is performed by causing the processor 4a to execute the program.

FIG. 6B is a conceptual diagram illustrating a configuration example for performing a switching speed control in the inverter controller 4. The inverter controller 4 includes a processor 40a, a memory 40b, a drive circuit 40c, and a resistor circuit RG, which are connected to each other via a communication bus 150. The processor 40a, the memory 40b, and the drive circuit 40c constitutes the control driver F illustrated in FIG. 2. The processor 40a calculates a signal waveform for driving the inverter device 1 from the input accelerator opening X or the rotation position or the rotation speed of the motor M which is fed back if necessary, and transmits an instruction on the signal waveform to the drive circuit 40c via the communication bus 150.

The memory 40b includes a nonvolatile memory and a volatile memory, and a processing program for calculating the signal waveform is stored in the nonvolatile memory. The processing program read from the nonvolatile memory is loaded into the volatile memory and data input from the outside, data in computation processes, or the like is also temporarily stored therein.

The drive circuit 40c includes a controller 141, a driver 142, and a selector 143. The controller 141 receives the instruction on the signal waveform to be output to the inverter device 1 via the communication bus 150 from the processor 40a, generates a drive control signal Vp using a carrier generating circuit and a comparator therein, and outputs the generated control signal to the driver 142. The drive control signal Vp is input to the driver 142 via a photo coupler, a pulse transformer, or the like in order to insulate the controller 141 and the driver 142 from each other. The driver 142 generates source gate drive voltage Vg1 to Vg6 on the basis of the drive control signal Vp and outputs the generated source gate drive voltages to the resistor circuits RG The driver 142 includes a switch circuit 142a. The switch circuit 142a selects a voltage source outputting the voltage Vrg1 or a voltage source outputting the voltage Vrg2, for example, on the basis of a switching signal Vs input from the selector 143 via the photo coupler, and outputs the gate voltage Vrg1 or Vrg2 to the resistor circuit RG The resistor circuit RG generates gate drive voltages Vg1′ to Vg6′ to be output to the switching elements T1 to T6 of the inverter device 1 as waveforms corresponding to the gate voltages Vrg1 and Vrg2 on the basis of the source gate drive voltages Vg1 to Vg6.

Here, when the level of the motor current Im is low or when a condition of a predetermined range of the system voltage VH and a predetermined range of the atmospheric pressure Pa is satisfied, the control voltage to be output to the gate resistor circuit RG can be switched. Accordingly, the detected values of the motor current Im, the system voltage VH, and the atmospheric pressure Pa are output as a binary-valued signal, which indicates whether the conditions are satisfied, to the current monitor SI, the voltage monitor. SV, and the atmospheric pressure monitor SP, and are input to the selector 143. The selector 143 has a logic circuit that generates the switching signal Vs to the switch circuit 142a of the driver 142 from the input detected values. When only the detected value of the motor current Im is used, the logic circuit can be constituted by a buffer gate, a NOT gate, or the like for outputting which of high and low switching speeds corresponds to the detected value of the motor current Im. When the detected values of the system voltage VH and the atmospheric pressure Pa are added to the factor for determining the switching speed, a combinational circuit of an AND gate, a NOR gate, or the like for determining and outputting whether the total detected values satisfy the condition may be used. By inputting the detected values of the motor current Im, the system voltage VH, and the atmospheric pressure Pa to the controller 141 or the driver 142 without being binarized and comparing the detected values with reference values by the use of a comparator in the controller 141 or the driver 142, the switching signal Vs to the switch circuit 142a may be generated.

In the above-mentioned configuration illustrated in FIG. 6B, the control of switching the switching speeds of the switching elements T1 to T6 is performed by only hardware such as the driver 142 or the controller 141.

Hitherto, the embodiment of the invention has been described.

In the above-mentioned example, the switching element of the inverter device 1 is an IGBT, but may be another switching element such as an LDMOS transistor and is not limited to a power element. The switching speed is changed in two steps in the above-mentioned example, but may be set to three or more steps or may be changed continuously. When the switching speed is changed in plural steps, a control of setting the switching speed to be lower as the level of the switching threshold value than which the magnitude of the motor current Im becomes lower can be performed. When the switching speed is changed continuously, for example, the gate voltage to the MOS transistor of the resistor circuit RG described with reference to FIG. 2 can be continuously changed. A hysteresis characteristic that the switching threshold value when the motor current Im decreases and the switching threshold value when the motor current Im increases are different from each other may be given to the switching speed control. In the hysteresis characteristic, for example, when the switching threshold value when the motor current Im increases is set to be greater than the switching threshold value when the motor current Im decreases, the switching speed can be set to be higher after waiting for the state where the dielectric strength is stably recovered from the state where the motor current Im temporarily decreases and thus the dielectric strength decreases.

In the above-mentioned example, the load of the inverter device 1 is an AC motor, but is not limited to the AC motor and may be a general AC load. That is, a control of setting the switching speed of the switching element to be smaller on the lower-level side of the magnitude of the current flowing in the AC load than on the higher-level side of the magnitude of the current is carried out. The inverter device 1 is not limited to a three-phase inverter device, but may be a single-phase or two-phase or more inverter device. When the inverter device is applied to a general AC load or when the AC load is a motor but the dielectric breakdown between the coil conductors does not cause any problem, a noise countermeasure such as installation of a Snubber circuit provided in the related art can be omitted.

The present invention can be generally applied to a controller of an inverter device that drives an AC load and that performs a control of a vehicle running motor, a control of a compressor motor of an air conditioner, and the like.

1. An inverter controller configured to control an inverter device that is configured to generate a drive voltage of an AC load by a switching operation of a switching element that a reflux diode is connected to, wherein
the inverter controller is configured to perform a control of setting a switching speed of the switching element to be smaller on a lower level side of a magnitude of a current flowing in the AC load than on a higher level side of the magnitude of the current.

2. The inverter controller according to claim 1 wherein
the inverter controller is configured to perform the control when an input voltage to the inverter device is greater than a predetermined voltage value.

3. The inverter controller according to claim 1 wherein
the inverter controller is configured to perform the control when atmospheric pressure of a surrounding environment is equal to or less than a predetermined pressure.

4. The inverter controller according to claim 1 wherein
the inverter controller is configured to perform the control when an input voltage to the inverter device is greater than a predetermined voltage value and atmospheric pressure of a surrounding environment is equal to or less than a predetermined pressure.

5. The inverter controller according to claim 1, wherein the AC load is a motor.

6. The inverter controller according to claim 1, comprising:
a drive circuit that generates a source gate drive voltage; and
a resistor circuit that generates a gate drive voltage from the source gate drive voltage, the gate drive voltage being output to the switching element.

7. A control method of an inverter controller configured to control an inverter device that is configured to generate a drive voltage of an AC load by a switching operation of a switching element that a reflux diode is connected to, the control method comprising
setting a switching speed of the switching element to be smaller on a lower level side of the magnitude of a current flowing in the AC load than on a higher level side of the magnitude of the current.
